(19) United States
(12) Patent Application Publication
(10) Pub. No.: US 2014/0267443 A1
(43) Pub. Date: Sep. 18, 2014

(54) ELECTROMECHANICAL SYSTEMS DEVICE WITH SEGMENTED ELECTRODES

(71) Applicant: QUALCOMM MEMS TECHNOLOGIES, INC., San Diego, CA (US)

(72) Inventors: Edward K. Chan, San Diego, CA (US); John H. Hong, San Clemente, CA (US); Chong U. Lee, San Diego, CA (US); Isak C. Reines, San Diego, CA (US)

(73) Assignee: QUALCOMM MEMS Technologies, Inc., San Diego, CA (US)

(21) Appl. No.: 13/804,261

(22) Filed: Mar. 14, 2013

(51) Int. Cl. G02B 26/00; G09G 5/10

(52) U.S. Cl. CPC G02B 26/001; G09G 5/10
USPC 345/690; 359/291; 264/104

(57) ABSTRACT

This disclosure provides systems, methods and apparatus for increasing a range of stable travel positions of a movable layer within electromechanical systems (EMS) devices. In one aspect, an electrically isolated floating electrode can be disposed between a driving electrode within a movable layer and a fixed electrode in order to increase a stable travel range of the movable layer. By segmenting the electrically isolated floating electrode into multiple isolated electrode segments, unbalanced charge accumulation in response to tilting of the movable layer can be constrained to further increase the stable travel range of the movable layer.

### TECHNICAL FIELD

This disclosure relates to electromechanical systems (EMS) devices having segmented electrodes and methods of fabricating the same.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

When an EMS device includes a movable layer, the range of stable travel positions through which the movable layer can be electrostatically displaced may be limited at least in part by a tendency of the movable layer to tilt. This tilting can be due, at least in part, to variances or imperfections in the manufacture of the EMS device. The rotational stability of a movable layer can affect the stable travel range of the EMS, and rotational instability can limit the performance of the EMS device.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical systems (EMS) device, including a first electrode supported by a substrate, a movable layer separated from the fixed electrode by a gap, where the movable layer includes a driving electrode, where application of a voltage between the driving electrode and the first electrode electrostatically displaces the movable layer, a dielectric layer located between the driving electrode and the first electrode, and a plurality of isolated electrode segments located between the driving electrode and the fixed electrode, where each of the plurality of isolated electrode segments are electrically isolated from both the driving electrode and from the other isolated electrode segments.

In some implementations, each individual isolated electrode segment can be surrounded on all sides by dielectric material. In further implementations, the plurality of isolated electrode segments can include four isolated electrical segments separated by two substantially perpendicular sections of dielectric material.

In some implementations, the device can include an interferometric modulator. In a first further implementation, the first electrode can include an optical absorber, and the isolated electrode segments can include a reflective material. In a second further implementation, the movable layer can be movable over a range of stable positions in which application of a voltage between the first electrode and the driving electrode can maintain the movable layer at a position within the range of stable positions. In such an implementation, the interferometric modulator can be configured to reflect substantially white light when the movable layer is collapsed against the first electrode, and the interferometric modulator can be configured to appear black when the movable layer is maintained in at least one position within the range of stable positions.

In some implementations, the device can additionally include driving circuitry configured for moving the movable layer through a range of stable positions between a relaxed position and a minimum stable distance from the first electrode. In further implementations, the minimum stable distance can be less than 40% of the distance between the relaxed position and the first electrode.

Another innovative aspect of the subject matter described in this disclosure can be implemented in an electromechanical systems (EMS) device, including a first electrode supported by a substrate, a movable layer separated from the fixed electrode by a gap, where the movable layer includes a driving electrode, where application of a voltage between the driving electrode and the first electrode electrostatically displaces the movable layer, a dielectric layer located between the driving electrode and the first electrode, and means for inhibiting an imbalanced accumulation of charge within the movable layer to increase a range of stable positions of the movable layer.

In some implementations, the inhibiting means can include a plurality of isolated electrode segments located between the driving electrode and the fixed electrode, and each of the plurality of isolated electrode segments can be electrically isolated from both the driving electrode and from the other isolated electrode segments. In at least a first further implementation, each individual isolated electrode segment can be surrounded on all sides by dielectric material. In at least a second further implementation, the plurality of isolated electrode segments can include four isolated electrical segments separated by two substantially perpendicular sections of dielectric material.

Another innovative aspect of the subject matter described in this disclosure can be implemented in a method of fabricating an electromechanical systems (EMS) device, including forming a first dielectric layer over a sacrificial layer, forming a first electrode layer over the first dielectric layer, patterning the first electrode layer to form a plurality of isolated electrode segments, forming a second dielectric layer over the plurality of isolated electrode segments, and forming a second electrode layer over the second dielectric layer.

Details of one or more implementations of the subject matter described in this disclosure are set forth in the accompanying drawings and the description below. Although the examples provided in this disclosure are primarily described in terms of EMS and MEMS-based displays, the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIGS. 5A and 5B are schematic exploded partial perspective views of a portion of an electromechanical systems (EMS) package including an array of EMS elements and a backplate.

FIG. 6 is a schematic cross-section showing an example of an IMOD being driven in an analog fashion.

FIG. 7 is a schematic cross-section showing an example of another example of an analog IMOD including an isolated electrode.

FIG. 8A is a schematic cross-section showing an example of another example of an analog IMOD in which an isolated electrode is separated into multiple isolated electrode segments.

FIG. 8B is a cross-sectional view of the movable layer of the analog IMOD of FIG. 8A, taken along the line 8B-8B of FIG. 8A.

FIGS. 9A-9D are cross-sectional illustrations of various stages in a process of fabricating an analog IMOD having isolated electrode segments.

FIG. 10 is a flow diagram illustrating a fabrication process for an analog IMOD having isolated electrode segments, which may include the stages illustrated in FIGS. 9A-9D.

FIG. 11 is a cross-sectional view of an example of a movable layer patterned to include support arms.

FIGS. 12A and 12B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

By driving a movable layer of an EMS device over a range of stable positions, additional precision and functionality of the EMS device may be provided. For example, an IMOD having a movable reflective layer may be driven in a multi-state (and when the number of multiple states is sufficiently large, an analog or near-analog) manner to move the movable reflective layer over a range of positions to cause the IMOD to reflect a range of possible colors. The range of stable positions can depend on, for example, the structure and components of the EMS device, but can also be affected by imperfections or variance in the fabrication of the EMS device. In some EMS devices, a slight rotational instability can lead to unintended collapse of an electrostatically displaced movable layer when the movable layer is near the edge of a stable range of positions, due to imbalanced charge accumulation on the movable layer which leads to tilting and subsequent collapse of the movable layer. The practical range of stable positions of such an EMS device may be significantly less than a theoretical range of stable positions for an EMS device of the same design. By separating an electrode in the movable layer into electrically isolated electrode segments, some of the charge accumulation resulting from rotational instability can be constrained to positions where it exerts less of a rotational moment on the movable layer of the EMS device, increasing the range of stable positions of the EMS device.

Particular implementations of the subject matter described in this disclosure can be implemented to realize one or more of the following potential advantages. In some implementations, dividing a movable electrode along two perpendicular axes provides a significant increase in the stable range of the EMS device without a substantial reduction in the total electrode area. In implementations in which the EMS device is an IMOD configured to be driven in a multi-state manner, extending the stable travel range of the multi-state IMOD can extend the range of colors that can be reflected by the multi-state IMOD.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIG. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 4D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

FIGS. 5A and 5B are schematic exploded partial perspective views of a portion of an EMS package 91 including an array 36 of EMS elements and a backplate 92. FIG. 5A] is shown with two corners of the backplate 92 cut away to better illustrate certain portions of the backplate 92, while FIG. 5B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 5A and 5B, the backplate 92 can include one or more backplate components 94a and 94b, which can be partially or wholly embedded in the backplate 92. As can be seen in FIG. 5A, backplate component 94a is embedded in the backplate 92. As can be seen in FIGS. 5A and 5B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 5B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 5A and 5B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 5A and 5B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

The IMODs 12 of FIG. 1 are illustrated in only two positions, a relaxed position in which no voltage is applied between the movable layer 14 and the conductive absorber layer 16, and an actuated state in which a voltage sufficient to collapse the movable layer 14 against the conductive absorber layer 16 has been applied. However, an IMOD 12 may also be driven in a multi-state, or an analog or near-analog, manner. An EMS device such as IMOD 12 may function essentially as a parallel plate capacitor in which one of the electrodes is movable relative to another electrode. A movable electrode such as the movable layer 14 will move to an equilibrium position between the electrostatic force resulting from a voltage difference between the movable electrode and a fixed electrode such as the conductive absorber 16 and a restoring force due to the displacement of the movable layer 14 from a resting position. In some implementations, the movable layer 14 or similar movable electrode may include a reflective layer, and may be referred to interchangeably herein as a mirror or a movable mirror. However, even though certain implementations may refer to a mirror or a movable mirror, it will be understood that the description of those implementations is not necessarily intended to exclude other limitations in which a movable layer may be less reflective or otherwise less suitable as a mirror, unless explicitly noted otherwise.

FIG. 6 is a schematic cross-section showing an example of an IMOD being driven in a multi-state fashion. It is understood that the term multi-state may also include the idea of driving an IMOD in an analog fashion, particularly as the number of possible states that the IMOD can be driven to becomes very large. Array driver 22 or another voltage source can be used to apply a voltage less than an actuation voltage of the IMOD 12 between the movable layer 14 and the conductive absorber 16 in order to move the movable layer 14 within a stable travel range R_{S} of the IMOD 12 between a maximum height h of the cavity 19 and a minimum stability height h_{S} at the end of the stable travel range R_{S}. In the illustrated implementation, in which the voltage is applied directly between movable layer 14 and conductive absorber 16, the stable travel range R_{S} will be roughly one-third of the height of the maximum gap height h. Upon application of a voltage which is equal to or exceeds the actuation voltage of the IMOD 12, the movable layer 14 will collapse against the conductive absorber layer 16.

As the movable mirror 14 is moved relative to the conductive absorber layer 16, the height of gap 19 between the mirror 14 and the optical absorber 16 will change, and the color reflected by the IMOD 12 will vary. An IMOD 12 driven in a multi-state manner can therefore provide a particular color response in response to application of a particular voltage. This color response can be controlled in part through the selection of particular materials for the components of IMOD 12, as well as the inclusion of intervening layers between the movable mirror 14 and the optical absorber 16 to maintain a desired spacing between the mirror 14 and the optical absorber 16 when the mirror 14 is in a collapsed state.

However, the limited stable travel range of IMOD 12 places constraints on the range of possible colors within the stable travel range of the IMOD 12 when driven in a multi-state manner. In some implementations, for example, design of the IMOD 12 to have a white state in the collapsed position places the black state of the IMOD 12 near the bottom of the gap, outside of the stable travel range of the IMOD 12. More generally, the stable travel range of the IMOD 12 may constrain the colors that can be reflected by the IMOD 12, and positions of the mirror 14 outside the stable travel range of the IMOD 12 may correspond to additional colors that could be reflected by the IMOD 12 if the stable travel range were larger. Even when the IMOD 12 is designed to have a stable travel range large enough to reflect a desired range of colors, imperfections in the fabrication of the IMOD 12 may reduce the actual stable travel range of the IMOD 12 in practice, and a larger stable travel range would provide increased reliability. In some implementations, the structure of an IMOD or similar EMS device may be modified to provide an increased stable travel range for a movable layer such as a movable mirror.

FIG. 7 is a schematic cross-section showing an example of another example of a multi-state IMOD including an isolated electrode. The IMOD 100 includes an optical absorber 116 supported by a substrate 120. As described above, the optical absorber 116 may serve as a fixed electrode as shown, or may be formed adjacent another conductive layer which forms part of a fixed electrode. A movable layer 130 is separated from the optical absorber 116 by a gap 119 having a maximum height h. The movable layer 130 includes a driving electrode 160 disposed on the side of the movable layer 130 opposite the optical absorber 116, a dielectric layer 150, and an isolated electrode 140 disposed on the opposite side of the dielectric layer 150 from the driving electrode 160. The isolated electrode 140 can serve as a mirror or reflective layer in the IMOD 100, similar to the reflector 14 of the IMOD 12 of FIGS. 1 and 6.

A voltage source 122 which can be in some implementations an array driver and associated circuitry is in electrical communication with both the driving electrode 160 and the optical absorber 116 and can apply a voltage between the driving electrode 130 and the optical absorber 116 to control the position of the movable layer 130 relative to the optical absorber 116 and change the color reflected by the IMOD 100. Unlike the reflector 14 of the IMOD 12 of FIGS. 1 and 6, the isolated electrode 140 is not in electrical communication with the voltage source 122 or other array driver circuitry. The voltage source 122 and associated circuitry are configured to apply multiple discrete driving voltages to drive the IMOD 100 in a multi-state, near-analog, or analog fashion, in contrast to the bi-stable operation described above.

Because the isolated or “floating” electrode 140 is disposed between the driving electrode 160 and the optical absorber 116, the IMOD 100 no longer behaves as a single capacitor with the driving electrode 160 and the optical absorber 116 as the capacitor plates, but rather as two capacitors in series with one another. Because of this, the stable travel range of the mirror is increased substantially, significantly increasing the range of colors that can be reflected by the IMOD 100 when driven in a multi-state manner. In some implementations, the thickness of the dielectric layer 150 is chosen such that the effective stable travel range of the movable layer 130 is roughly ⅓ of the electrical distance between the driving electrode 160 and the optical absorber 116. When the thickness of the dielectric layer 150 is sufficiently large, the stable travel range of the movable layer 130 may be increased to roughly 60% of the initial gap distance. However, variations or imperfections in the movable layer 130 may limit the stable travel range of the movable layer 130 before a theoretical end of an ideal stable travel range R_{I} is reached. In other implementations, the series capacitor can be implemented in a driving thin film transistor within circuitry associated with the array driver 122, rather than being implemented within the movable layer 130 itself.

In some implementations, as mentioned above, the stable range of the IMOD 100 may terminate not with the collapse of the movable layer 130 against the optical absorber 116 at a theoretical end of an ideal stable travel range R_{I} due to a lack of stable positions within the remainder of the gap 119, but rather due to tilting or rotational instability of the movable layer 130. Due to manufacturing imperfections, the movable layer 130 may be slightly asymmetrically supported, with the restoring force at one side of the movable layer 130 being greater than the restoring force at the other side of the movable layer 130. As the movable layer 130 travels beyond a point roughly 60% of the way through the gap, where the gap 119 is reduced to the minimum stability height hₛ, this imbalance of the restoring force causes an initial tilt in the mirror. The minimum stability height hs is within an ideal stable travel range R_{I}, but the actual stable travel range R_{S} in practice is less than the ideal stable travel range R_{I}. This tilt in the movable layer 130 induces additional charge accumulation on the portion of the isolated electrode 140 closest to the optical absorber 116, collapsing that edge of the movable layer 130 against the optical absorber 116.

In some implementation, the cumulative effect of charge accumulation can be minimized or controlled by constraining the accumulation of charge within the movable layer. In particular, by segmenting the floating electrode into a plurality of isolated electrode segments, the flow of charge between those segments can be inhibited, increasing the stable travel range of an EMS device such as an IMOD.

FIG. 8A is a schematic cross-section showing an example of another example of a multi-state IMOD in which an isolated electrode is separated into multiple isolated electrode segments. The IMOD 200 of FIG. 8A is similar to the IMOD 100 of FIG. 1, and includes an optical absorber 216 supported by a substrate 202 and spaced apart from a movable layer such as mirror 230 by a gap 219 having a maximum height h. The mirror 230 includes multiple isolated electrode segments 240a and 240b and a driving electrode 260 located on the opposite side of a dielectric layer 250 as the isolated electrode segments 240a and 240b. Additional dielectric material such as underlying dielectric layer 252 may extend underneath and between the electrode segments 240a and 240b, in order to ensure that the electrode segments 240a and 240b remain electrically isolated from one another and from other conductive components of the IMOD 200. A voltage source 222 such as an array driver and associated circuitry can be used to apply a voltage between the driving electrode 260 and the optical absorber 216. As discussed above, an array driver and associated circuitry can be in communication with a processor, allowing the processor to communicate with each of the driving electrode 260 and the optical absorber 216 via the array driver and associated circuitry.

FIG. 8B is cross-sectional view of the movable layer of the multi-state IMOD of FIG. 8A, taken along the line 8B-8B of FIG. 8A. It can be seen that the mirror 230 includes four symmetrical electrode segments 240a-240d, separated by one another by portions of the dielectric material 250. In particular, the electrode segments are segmented along two perpendicular axes of rotation of the mirror 220. A strip 254 of the dielectric material 252 isolates electrode segments 240a and 240b from electrode segments 240c and 240d, respectively. Similarly, a strip 256 of the dielectric material 252 isolates electrode segments 240a and 240c from electrode segments 240b and 240d, respectively. The strips 254 and 256 are generally perpendicular to one another as illustrated in order to segment the floating electrodes along two perpendicular axes of rotation. An outer section 245 of dielectric material extends around the outer edges of electrode segments 240a-240d to fully encapsulate the electrode segments 240a-240d.

The segmentation of a floating electrode into the multiple electrode segments 240a-240d of IMOD 200 illustrated FIGS. 2A and 2B increases the stable travel range R_{S} of the mirror 230. The minimum stability height h_{S} at which tilting instability causes collapse of the mirror 230 is closer to the optical absorber 216 when compared to minimum stability height h_{S} of the IMOD 100 shown in FIG. 7. As noted above, this increase in stable travel range R_{S} of the mirror 230 is due to the isolation of the electrode segments 240a-240d from one another. It can be seen in FIG. 8A that the actual stable travel range R_{S} of the mirror 230 is closer to the ideal stable travel range R_{I} than the stable travel range of the mirror 130 of IMOD 100 (see FIG. 7).

When the mirror 230 begins to tilt, two of the isolated electrode segments 240a-240d will be located closer to the optical absorber 216, and two of the isolated electrode segments 240a-240d will be located more distant from the optical absorber 216. The amount of charge which will shift to the outer edges of the electrode segments 240a-240d closest to the optical absorber 216 is less than the amount of charge that would shift to the outer edge of an isolated electrode if the isolated electrode was a single electrode. In some implementations, the amount of charge that will shift to the outer edges of the electrode segments 240a-240d closest to the optical absorber 216 may be on the order of half the charge that would shift to the outer edge of an isolated electrode if the isolated electrode was a single electrode. The exact amount of charge that will shift to the outer edges of a segmented electrode may vary in different implementations, and may be slightly more than half due to non-linear capacitive distribution of charge in a tilted electrode, but will nevertheless be significantly less than in a non-segmented electrode. This division of the charge accumulation occurs because the charge on the more distant electrode segments on the side of the mirror 230 not tilted downward cannot move through the separating dielectric material 254 or 256. Rather, the charge in the electrode segments on the side of the mirror 230 not tilted downward will accumulate on an inner edge of these more distant electrode segments adjacent the separating dielectric material 254 or 256. The electrode segments 240a-240d thus provide a means for inhibiting an imbalanced accumulation of charge within the mirror 230 to increase a range of stable positions of the mirror 230.

Because these inner edges are offset from the edge of the mirror 230 tilted downward and towards the optical absorber 216, the rotational moment induced by electrostatic attraction due to the charge accumulation on the edge of the more distant electrode segments will not be as large as the rotational moment induced if the isolated electrode were a contiguous structure. The smaller rotational moment is due to the shorter distance between the location of charge accumulation on the more distant electrode segments and the axis of tilting or rotation of the mirror 250. In the illustrated implementation, in which the floating electrode is divided into four generally symmetrical electrode segments 240a-240d, the charge accumulation on the pair of more distant electrode segments may exert a force which acts at points very close to the axis of rotation of the mirror 230, and therefore exert almost no rotational moment on the mirror 230.

Because the charge that can be shifted due to tilting the mirror 230 is constrained by the segmentation of the electrode segments 240a-240d, the stable travel range R_{S} of the mirror 230 of IMOD 200 is increased to roughly 80% of the maximum gap height h. For a given IMOD design, the segmentation of a floating electrode can significantly increasing the range of colors which can be reflected by the IMOD 200 when compared to the same design including contiguous floating electrode such as the electrode 140 of IMOD 100 shown in FIG. 7.

The isolated electrode segments and the surrounding dielectric material are designed and fabricated to ensure electrical isolation of the electrode segments. If the electrode segments are not well-insulated, and charge accumulates on the electrode segments over time, the operation of the EMS device will be affected. Due to the isolation of the electrode segments, in some implementations accumulated charge may be difficult or impossible to remove.

FIGS. 9A-9E are cross-sectional illustrations of various stages in a process of fabricating a multi-state IMOD having isolated electrode segments. FIG. 10 is a flow diagram illustrating a fabrication process for a multi-state IMOD having isolated electrode segments, which may include the stages illustrated in FIGS. 9A-9E. In some implementations, the fabrication process may also include the stages illustrated and described with respect to FIGS. 4A-4C.

The fabrication process 400 begins at a block 405 where at least a first dielectric layer is formed over a sacrificial layer. As can be seen in FIG. 9A, a conductive absorber layer 316 is formed over a substrate 302, a sacrificial layer 325 is formed over the conductive absorber layer 316, and a first dielectric layer 352 is formed over the sacrificial layer 325.

As discussed above with respect to FIGS. 4A-4C, the conductive absorber layer 316 need not be a single layer, but may instead include an optical absorber layer and a conductive layer, and additional optical layers may be formed over the conductive absorber layer 316 prior to formation of the sacrificial layer 325. Additional components not shown in FIG. 9A may also be formed prior to formation of the sacrificial layer 325, such as conductive bussing structures or masking or shielding structures. The conductive absorber layer 316 may be patterned to form strip electrodes prior to formation of the sacrificial material 325, and the sacrificial layer may be similarly patterned to form apertures for support structures (not shown in FIG. 9A) prior to deposition of overlying layers, as described with respect to FIG. 4C, for example.

In some implementations, the first dielectric layer 352 may include more than one layer, and the material and thickness of the layer or layers in the dielectric layer 352 may be selected for their optical properties. In other implementations, such as when a non-optical EMS device is formed, the conductive absorber layer 316 may be replaced with an opaque material, and the optical properties of the dielectric layer 352 may not be important.

In some implementations of IMODs or other optical EMS devices, the first dielectric layer 352 may be a stack of discrete dielectric layers formed over the sacrificial layer 325, despite being referred to for convenience as a “layer” and illustrated as a single layer in FIG. 8A, FIG. 9A, and elsewhere throughout the specification. For example, the first dielectric layer 352 can in some implementations be a stack which includes a first dielectric sublayer formed over sacrificial layer 325 and including a material with a high index of refraction, followed by a second dielectric sublayer formed over the first dielectric sublayer and including another material with a lower index of refraction than the material forming the first dielectric sublayer. The lower index dielectric sublayer may have a lower chromatic dispersion than that of the higher index dielectric sublayer. In some implementations, the higher index dielectric sublayer may include a material such as titanium dioxide (TiO₂), zirconium dioxide (ZrO₂), or niobium pentoxide (Nb₂O₅), although other dielectric materials may also be used. Similarly, in some implementation, the lower index dielectric sublayer may include a material such as silicon dioxide (SiO₂) or silicon oxynitride (SiON).

In some implementations, the first dielectric layer 352 may include a dielectric stack configured such that the interferometric modulator is capable of reflecting a white color when a movable layer including the first dielectric layer 352 is collapsed against a stationary electrode such as the conductive absorber layer 316, and the interferometric modulator is configured to appear black when the movable layer is maintained in at least one position within the range of stable positions.

In one specific implementation, the first dielectric layer 352 may include a first dielectric sublayer formed over the sacrificial layer 325 and including a layer of TiO₂ roughly 21 nm in thickness, and a second dielectric sublayer formed over the first dielectric sublayer and including a layer of SiON roughly 80 nm in thickness. In another specific implementation, the first dielectric layer 352 may include a first dielectric sublayer formed over the sacrificial layer 325 and including a layer of TiO₂ roughly 31 nm in thickness, and a second dielectric sublayer formed over the first dielectric sublayer and including a layer of SiON roughly 72 nm in thickness. In other particular implementations, other materials and/or other thicknesses may be used to form dielectric sublayers within the first dielectric layer 352, and any appropriate number of sublayers may included in the first dielectric layer 352.

In other implementations, the order of the dielectric sublayers in the stack of layers forming first dielectric layer 352 can be reversed, such that the dielectric sublayer formed from the higher index material can be formed after and over the dielectric sublayer formed from the lower index material, so that the higher index material will be closer to a subsequently deposited segmented electrode and/or reflector.

The fabrication process 400 then moves to a block 410 where a first electrode layer is formed over the first dielectric layer. As can also be seen in FIG. 9A, a first electrode layer 340 is formed over the first dielectric layer 352. The first electrode layer 340 may serve as the mirror in a multi-state IMOD, and the material and thickness of the first electrode layer 340 may be chosen in part on the reflectivity of the electrode layer 340. In some implementation, the electrode layer 340 may include a layer of aluminum (Al) or an aluminum alloy. However, as noted above, in a non-optical EMS device, the reflectivity of the electrode layer 340 may not be relevant, and a less reflective material may be used.

The fabrication process 400 then moves to a block 415 where the first electrode layer is patterned to form a plurality of isolated electrode segments. As can be seen in FIG. 9B, the first electrode layer 340 has been patterned to form at least isolated electrical segments 340a and 340b. In some implementations, the first electrode layer 340 is patterned to form four symmetrical isolated electrode segments such as isolated electrical segments 340a and 340b for each multi-state IMOD element being fabricated. In other implementations, however, other numbers and shapes of isolated electrical segments can be formed. Increasing the number of isolated electrical segments beyond four may increase the stable travel range of the movable layer in the finished IMOD. However, further increases in the number of isolated electrical segments will reduce the total area covered by the isolated electrical segments due to additional cuts between the isolated electrical segments, increasing the actuation voltage of the IMOD and decreasing the fill factor of the mirror.

The fabrication process 400 then moves to a block 420 where a second dielectric layer is formed over the plurality of isolated electrode segments. As can also be seen in FIG. 9B, the second dielectric layer 350 extends over the isolated electrical segments 340a and 340b and, in conjunction with the first dielectric layer 352, surrounds the isolated electrical segments 340a and 340b. The isolated electrical segments 340a and 340b are therefore surrounded on all sides by dielectric material, which fills the regions such as region 356 between the isolated electrical segments 340a and 340b. In the illustrated implementation, the upper surface of the second dielectric layer 350 is shown as planar, but in some implementations the second dielectric layer 350 may be conformal over the underlying isolated electrical segments 340a and 340b. The shape of the second dielectric layer 350 and any overlying layers may vary based on the material and deposition processes used to form the second dielectric layer 350. As discussed above with respect to the first dielectric layer 352, the second dielectric layer 350 may in some implementations also include a stack of layers, and are illustrated and described as a single layer for convenience and clarity.

The fabrication process 400 then moves to a block 425 where a second electrode layer is formed over the second dielectric layer. As can be seen in FIG. 9B, the second electrode layer 360 may be similar in thickness to the first electrode layer 340 patterned to form the isolated electrical segments 340a and 340b. By forming the second electrode layer 360 from the same material and in roughly the same thickness as the first electrode layer 340, stresses within the electrode layers 340 and 360, which may be due to deposition conditions or changes in temperature, may generally balance one another out and prevent undesirable flexure of the movable layer. In some implementations, additional layers (not shown) which are the same thickness and formed from the same material as the layer or layers used to form dielectric layer 352 may be formed over the second electrode layer 360, to provide additional symmetry and stress balancing.

Subsequent to the blocks illustrated in FIG. 10, a release etch may be performed to remove the sacrificial layer and release the IMOD. FIG. 9D shows the IMOD 300 after a release etch is performed to remove the sacrificial layer 325 (see FIG. 9C) to form a cavity 319.

The first dielectric layer 352, second dielectric layer 350, and second electrode layer 360 may have previously been patterned (not shown) to facilitate movement of the movable layer or mirror 330 towards the conductive absorber 316, and to electrically isolate adjacent IMODs 300 from one another. In some implementations, one or more of these layers may be patterned prior to deposition of any overlying layers, while in other implementations, these layers may be patterned via one or more etching processes after formation of the second electrode layer 360 and any overlying layers. In some implementations, the movable layer 330 may be patterned to form strips extending along connecting a row or column of IMODs 300, and may include additional widthwise cuts to facilitate at least the isolated electrical segments 340a and 340b of the movable layer 330 remaining in a position substantially parallel to the conductive absorber layer 316 when the movable layer 330 is electrostatically pulled downwards. In other implementations, the movable layer 330 may be patterned to form tethers or strips of material supporting the portion of the movable layer 330 including the isolated electrical segments 340a and 340b.

FIG. 11 is a cross-sectional view of an example of a movable layer patterned to include support arms. It can be seen that the movable layer 530, shown in a cross-section extending through the isolated electrode segments 540a-540d, has been patterned to include a support arm 570 extending from each side of a central region 542 including the isolated electrode segments 540a-540d. Each support arm 570 is in contact with the central region 542 along one side of the central region 542 via a connecting region 572. Each support arm 570 also extends generally parallel to the side of the central region 542 to which the support arm 570 is attached. The ends 574 of the support arms 570 may be, for example, in contact with support structures (not shown) to suspend the movable layer 530 over a conductive absorber layer. Although not visible in the cross-sectional view of FIG. 11, the movable layer 530 also includes a driving electrode electrically isolated from the isolated electrode segments. The driving electrode may be in electrical connection with an array driver and associated circuitry via, for example, a contiguous portion of the same metal layer used to form the driving electrode extending along at least one of the support arms 570.

In some implementations, the structure of the EMS device structure may be modified in other ways in conjunction with the implementations discussed above to increase the stable travel range of the EMS device. In other implementations, the area of a fixed electrode underlying a movable layer may be reduced in order to minimize the tilting moment that can be induced by accumulation of charge at one end of the movable layer. If the fixed electrode is made smaller while still remaining substantially centered, the magnitude of a tilting moment induced by the charge accumulation can be reduced by ensuring that the force acts at a point on the movable layer closer to the tilting axis. However, this reduction in electrode size may increase the voltage necessary to actuate the mirror, as discussed above, and thus represents a tradeoff between increased stability range and increased power consumption required to drive the device.

The segmentation of an electrode can be used to increase a stable travel range of that electrode, or a movable layer including such an electrode, whenever that electrode is being brought towards another conductive layer. In other implementations, for example, a three-terminal EMS device may be provided, which may include, for example, two electrodes configured to electrostatically displace the movable layer of an EMS device in opposite directions, which may increase the stable travel range of the EMS device at the cost of increased complexity in the design and/or operation of the EMS device. In a three-terminal EMS device, segmentation of a floating electrode which is within an electric field created by the other electrodes can therefore similarly prevent tilting due to imbalanced charge accumulation on the floating electrode.

Other modifications to and combinations of the implementations described herein are also possible. For example, some implementations may include a segmented floating electrode as well as a smaller fixed electrode to further increase the stable travel range of an EMS device. In some implementations, reducing the size of the fixed electrode may reduce the size of the optical absorber, which in turn reducing may reduce the size of the optically active area of the EMS device when the EMS device is a display element such as an interferometric modulator. In a further implementation, the size of the fixed electrode may be reduced without substantially reducing the optically active area of the display by segmenting the optical absorber into an electrically active interior area in electrical communication with driving circuitry and components and an electrically inactive outer area which is electrically isolated from the electrically active interior area. By providing a segmented optical absorber, the size of the fixed electrode may be reduced to reduce a tilting moment at the cost of increased actuation voltages, while the total area of the optical absorber may be substantially the same size as the total area of the segmented electrode to minimize a reduction in the optically active area of the display element. In other such implementations, the fixed electrode may be a separate component from the optical absorber, and may arranged over or under the optical absorber layer and electrically isolated from the optical absorber.

FIGS. 12A and 12B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems (EMS) device, comprising:
a first electrode supported by a substrate;
a movable layer separated from the fixed electrode by a gap, wherein the movable layer includes:
a driving electrode, wherein application of a voltage between the driving electrode and the first electrode electrostatically displaces the movable layer;
a dielectric layer located between the driving electrode and the first electrode; and
a plurality of isolated electrode segments located between the driving electrode and the fixed electrode, wherein each of the plurality of isolated electrode segments are electrically isolated from both the driving electrode and from the other isolated electrode segments.

2. The device of claim 1, wherein each individual isolated electrode segment is surrounded on all sides by dielectric material.

3. The device of claim 2, wherein the plurality of isolated electrode segments include four isolated electrical segments separated by two substantially perpendicular sections of dielectric material.

4. The device of claim 1, wherein the plurality of isolated electrode segments are recessed from the edges of the movable layer.

5. The device of claim 1, wherein the device includes an interferometric modulator.

6. The device of claim 5, wherein the first electrode includes an optical absorber, and wherein the isolated electrode segments include a reflective material.

7. The device of claim 5, wherein:
the movable layer is movable over a range of stable positions in which application of a voltage between the first electrode and the driving electrode maintains the movable layer at a position within the range of stable positions;
the interferometric modulator is configured to reflect substantially white light when the movable layer is collapsed against the first electrode; and
the interferometric modulator is configured to appear black when the movable layer is maintained in at least one position within the range of stable positions.

8. The device of claim 1, additionally including driving circuitry configured to apply a range of voltages between the first electrode and the driving electrode to move the movable layer through a range of stable positions between a relaxed position where no voltage is applied between the first electrode and the driving electrode and a minimum stable distance from the first electrode.

9. The device of claim 8, wherein the minimum stable distance is less than 40% of the distance between the relaxed position and the first electrode.

10. The device of claim 1, wherein a surface area of the fixed electrode is less than a surface area of the isolated electrode segments.

11. The device of claim 1, further including
a processor that is configured to communicate with at least one of the first electrode and the driving electrode, the processor being configured to process image data; and
a memory device that is configured to communicate with the processor.

12. The device of claim 11, further including:
a driver circuit configured to send at least one signal to at least one of the first electrode and the driving electrode; and
a controller configured to send at least a portion of the image data to the driver circuit.

13. The device of claim 11, further including an image source module configured to send the image data to the processor, wherein the image source module comprises at least one of a receiver, transceiver, and transmitter.

14. The device of claim 11, further including an input device configured to receive input data and to communicate the input data to the processor.

15. An electromechanical systems (EMS) device, comprising:
a first electrode supported by a substrate;
a movable layer separated from the fixed electrode by a gap, wherein the movable layer includes:
a driving electrode, wherein application of a voltage between the driving electrode and the first electrode electrostatically displaces the movable layer;
a dielectric layer located between the driving electrode and the first electrode; and
means for inhibiting an imbalanced accumulation of charge within the movable layer to increase a range of stable positions of the movable layer.

16. The device of claim 15, wherein the inhibiting means includes a plurality of isolated electrode segments located between the driving electrode and the fixed electrode, wherein each of the plurality of isolated electrode segments are electrically isolated from both the driving electrode and from the other isolated electrode segments.

17. The device of claim 16, wherein each individual isolated electrode segment is surrounded on all sides by dielectric material.

18. The device of claim 16, wherein the plurality of isolated electrode segments include four isolated electrical segments separated by two substantially perpendicular sections of dielectric material.

19. A method of fabricating an electromechanical systems (EMS) device, comprising:
forming a first dielectric layer over a sacrificial layer;
forming a first electrode layer over the first dielectric layer;
patterning the first electrode layer to form a plurality of isolated electrode segments;
forming a second dielectric layer over the plurality of isolated electrode segments; and
forming a second electrode layer over the second dielectric layer.

20. The method of claim 19, wherein the sacrificial layer is located over a third electrode layer, and wherein the third electrode layer is located over a substrate.

21. The method of claim 20, additionally including performing an etch to remove the sacrificial layer after formation of the second electrode layer to form a gap between the first dielectric layer and the third electrode.

22. The method of claim 19, wherein patterning the first electrode layer to form a plurality of isolated electrode segments includes patterning the first layer to form a group of four isolated electrical segments separated by two substantially perpendicular cuts extending through the first electrode layer.

23. The method of claim 19, wherein forming a first dielectric layer includes forming a stack of dielectric layers, the stack of dielectric layers including:
a first dielectric sublayer including a first material having a first index of refraction; and
a second dielectric sublayer including a second material having a second index of refraction, wherein the first index of refraction is greater than the second index of refraction.

24. The method of claim 23, wherein forming the stack of dielectric layers includes:
forming the first dielectric sublayer over the sacrificial layer; and
forming the second dielectric sublayer over the first dielectric sublayer.
